(19) United States
(12) Patent Application Publication
(10) Pub. No.: US 2005/0247505 A1
(43) Pub. Date: Nov. 10, 2005

(54) Frame and bracket system for motorized vehicle

(76) Inventor: Christopher N. Nagle, Perkasie, PA (US)

Correspondence Address: BUCHANAN INGERSOLL PC, 1835 MARKET STREET, 14TH FLOOR, PHILADELPHIA, PA, 19103-2985, US

(21) Appl. No.: 10/840,113

(22) Filed: May 6, 2004

(51) Int. Cl. B62D 21/17

(52) U.S. Cl. 180/312

(57) ABSTRACT

A frame for a motorized vehicle that is to be powered by a conventional automobile engine block supported in the frame, comprising: a steering neck tube; a support for the engine block which is formed by a left and right subframes extending rearward and longitudinally of said steering neck tube and on respective sides of said steering neck tube, then extending inward to form a continuous rear frame member; each of said left and right subframes having a downtube section that is affixed to said steering neck tube and which then extends outward, downward, and rearward from said head tube; each of said left and right subframes having a horizontal section adjacent to the rearward end of said downtube section, each said horizontal section extending rearward and longitudinally; and each of said left and right subframes having a tail section adjacent to the rearward end of said horizontal sections, each said tail section having a portion extending upward and rearward of said horizontal section.

### FIELD OF THE INVENTION

The present invention relates to a frame for a motorized vehicle and more particularly to a frame for a motorized vehicle that is to be powered by a conventional automobile engine.

### BACKGROUND OF THE INVENTION

In the world of motorcycling, motorcyclists are on a seemingly never-ending quest for power. To satisfy their customers' need for power, every year motorcycle manufacturers introduce new motorcycles that are more powerful than the previous years' motorcycles. Today, manufacturers are selling standard production street motorcycles that are capable of almost 200 miles per hour and whose engines produce 175 horsepower or more. Production motorcycles with those power and performance characteristics were virtually unheard of even 10 years ago. In conjunction with increasing the horsepower of motorcycles to meet motorcyclists needs, many motorcycle manufacturers have also reduced the weight of their vehicles to further increase the horsepower to weight ratio of their vehicles. As part of this effort, motorcycle manufacturers have attempted to develop lighter weight frames that, paradoxically, are expected to be able to withstand the greater forces associated with higher horsepower.

In addition to being attracted to the power of motorcycles, motorcyclists are also drawn to the visceral sensations that come with riding a motorcycle. Many motorcyclists seek motorcycles that are loud and which get louder during hard acceleration. In light of this, an entire industry of aftermarket exhaust system manufacturers has arisen whose primary purpose is to sell exhaust systems that are louder than the original equipment that comes standard with a motorcycle. Many motorcyclists also enjoy the vibrations and mechanical sounds that come directly from the motorcycle's engines, and many manufacturers design their motorcycles to accentuate these features by mounting the engines rigidly to the motorized vehicle frame, which increases the vibration felt by a rider, and by using certain engine designs that cause the engine to vibrate more than other designs and which cause the motorcycle engine to make distinct mechanical sounds.

Many motorcyclists are particularly attracted to cruiser-style motorcycles, the largest segment of motorcycles sold in the United States, because cruiser-style motorcycles add to the visceral sensations experienced by the rider. The low seat and the forward leg position typical of all cruiser-style motorcycles have the effect of amplifying all of the visceral sensations experienced by the rider.

In addition, riders of cruiser-style motorcycles have the added visual sensation of seeing the motorcycle engine and the various parts that make up the engine because the engine is not hidden by plastic bodywork that is common on other styles of motorcycles. The importance of this visual sensation to riders of cruiser-style motorcycles is apparent when it is considered that riders of Harley Davidson™ motorcycles, the largest seller of cruiser-style motorcycles, identify their motorcycles by reference to certain unique parts that make up the engine, calling their bikes “Pan-Heads,” “Knuckleheads,” “Flatheads,” “Shovelheads,” “Blockheads,” and “Fatheads” as dictated by the particular engine design on their bike. The importance of this visual sensation to riders of cruiser-style motorcycles becomes even more apparent when it is considered that manufacturers of certain cruiser-style motorcycles incorporate non-functional design pieces onto their engines that are meant to mimic functional parts on engines that are considered more desirable by motorcyclists.

In an effort to satisfy motorcyclists need for power, several manufacturers have developed motorized vehicles, which may have 2, 3, or even 4 wheels, that use a conventional automobile engine. Significantly, while these prior art motorized vehicles may have a larger engine than standard motorcycles, none satisfy the visceral requirements of motorcyclists. These motorcycles all fail in several respects. All have structural support tubing over the engine, which obscures the engine from the rider and lessens the visceral effect to the rider. Some have instrument panels or automobile-like dashboards between the rider and the engine, and/or shrouds covering parts of the engine, all of which obscure the engine and leave the rider with a view of the exhaust pipes exiting the engine and little more. Most have a design in which the motorcyclists riding position is such that the rider's legs are behind the engine rather than straddling the engine, completely eliminating the visceral effect to the rider of straddling a large automobile engine.

It is therefore a principal object of this invention to provide a lightweight yet strong frame for a motorized vehicle which is to be powered by a conventional automobile engine.

It is a further object of this invention to provide a frame for a motorized vehicle which is to be powered by a conventional automobile engine that has an underslung frame design.

It is another object of this invention to provide a frame for a motorized vehicle that is to be powered by a conventional automobile engine in which the rider's seat is positioned low and forward on the frame such that the rider's legs are on either side of the engine, giving the rider a sense of straddling the engine.

It is yet another object of this invention to provide a frame for a motorized vehicle which uses uniform size tubing for the entire frame, which makes the procurement and production process for the frame more simple and results in a frame design that is symmetrical and more aesthetically pleasing.

It is also an object of this invention to provide a frame for a motorized vehicle which uses uniform spacing between frame tubes, allowing the use of universal brackets throughout the frame to mount parts and accessories to the frame.

Further scope of the applicability of the present invention will become apparent from the detailed description given hereafter. However, it should be understood that the detailed description and specific examples, while indicating the preferred embodiments of the invention, are given as illustration, since various changes and modifications within the spirit and scope of the invention will become apparent to those skilled in the art from this detailed description.

### BRIEF DESCRIPTION OF THE DRAWINGS

FIG. 1 is a right side elevation view of a motorized vehicle frame constructed in accordance with a preferred embodiment of the invention;

FIG. 2 is a left side elevation view of the motorized vehicle frame;

FIG. 3 is a front elevation view of a universal bracket for use with the motorized vehicle frame;

FIG. 4 is a perspective view of a universal bracket for use with the motorized vehicle frame;

FIG. 5 is a front elevation view of another embodiment of a universal bracket for use with the motorized vehicle frame;

FIG. 6 is a perspective view of another embodiment of a universal bracket for use with the motorized vehicle frame;

FIG. 7 is a front elevation view of another embodiment of a universal bracket for use with the motorized vehicle frame;

FIG. 8 is a perspective view of another embodiment of a universal bracket for use with the motorized vehicle frame;

FIG. 9 is a front elevation view of another embodiment of a universal bracket for use with the motorized vehicle frame;

FIG. 10 is a perspective view of another embodiment of a universal bracket for use with the motorized vehicle frame;

FIG. 11 is a front elevation view of another embodiment of a universal bracket for use with the motorized vehicle frame;

FIG. 12 is a perspective view of another embodiment of a universal bracket for use with the motorized vehicle frame;

FIG. 13 is a front elevation view of another embodiment of a universal bracket for use with the motorized vehicle frame;

FIG. 14 is a perspective view of another embodiment of a universal bracket for use with the motorized vehicle frame;

FIG. 15 is a front elevation view of another embodiment of a universal bracket for use with the motorized vehicle frame;

FIG. 16 is a perspective view of another embodiment of a universal bracket for use with the motorized vehicle frame;

FIG. 17 is a front elevation view of another embodiment of a universal bracket for use with the motorized vehicle frame;

FIG. 18 is a perspective view of another embodiment of a universal bracket for use with the motorized vehicle frame;

FIG. 19 is a top plan view of the motorized vehicle frame;

FIG. 20 is a bottom plan view of the motorized vehicle frame;

FIG. 21 is a front elevation view of the motorized vehicle frame;

FIG. 22 is a rear elevation view of the motorized vehicle frame;

FIG. 23 is a front perspective view of the motorized vehicle frame;

FIG. 24 is a rear perspective view of the motorized vehicle frame;

FIG. 25 is a sectional view taken along line I-I in FIG. 19;

FIG. 26 is a sectional view taken along line II-II in FIG. 19

FIG. 27 is a section view taken along line III-III in FIG. 19;

FIG. 28 is a section view taken along line IV-IV in FIG. 19;

FIG. 29 is a perspective view of an alternator for use with the motorized vehicle frame;

FIG. 30 is a section view taken along line V-V in FIG. 19;

FIG. 31 is a section view taken along line VI-VI in FIG. 19; and

FIG. 32 is a section view taken along line VII-VII in FIG. 19.

### DETAILED DESCRIPTION

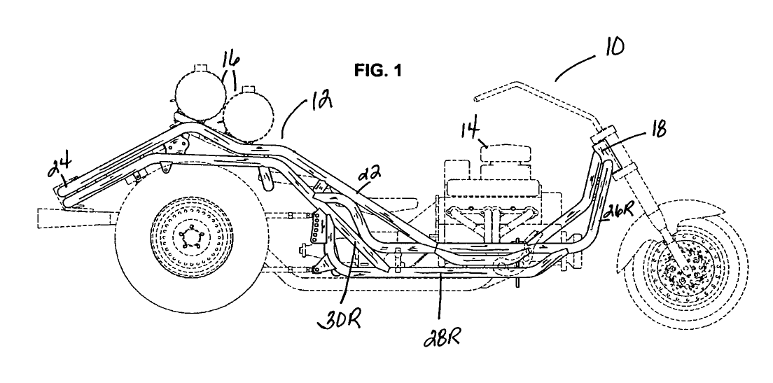

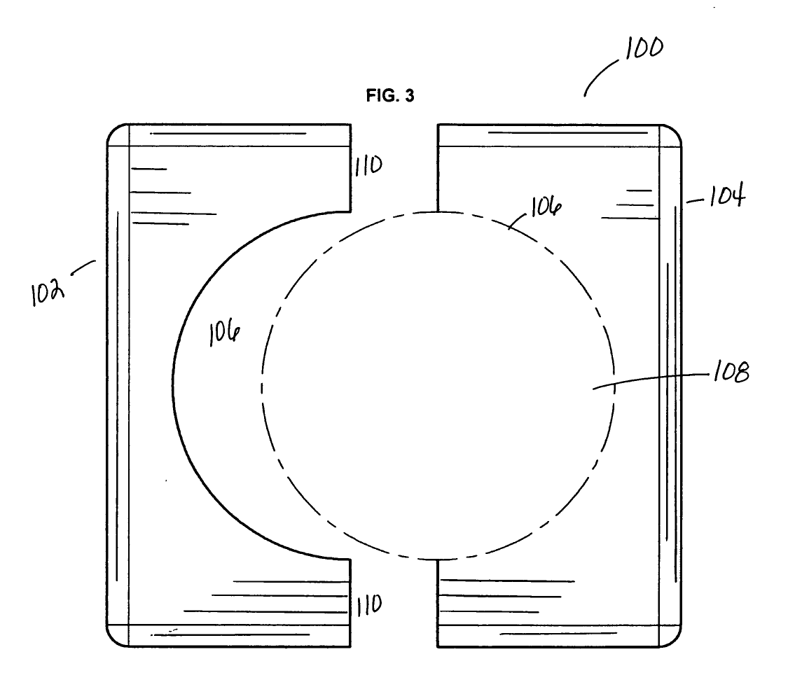

The following is a description of the embodiment of the present invention shown in FIGS. 1 through 32. FIGS. 1, 2, and 19 through 32 depict a lightweight frame for a motorized vehicle which is to be powered by a conventional automobile engine and FIGS. 3 through 18 depict a movable universal bracket system for the frame.

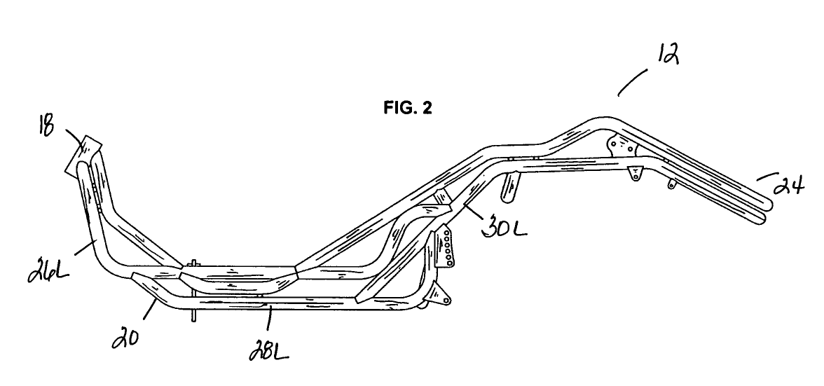

FIGS. 1 and 2 depict side elevation views of a motorized vehicle 10 which includes some of its essential parts. The motorized vehicle frame 12 carries a conventional automobile engine 14. The engine 14 is preferably a V-8 style engine, which adds to the visceral appeal of the motorized vehicle 10. The motorized vehicle frame 12 also carries at least one fuel tank 16.

The motorized vehicle frame 12 is composed of a steering neck tube 18, a left subframe 20L and a right subframe 20R affixed to the steering neck tube 18, and a rear frame member 24. In the preferred embodiment, the left and right subframes 20L, 20R and the rear frame member 24 each have a plurality of tubes. However, it is understood that the motor vehicle frame may be constructed from single tubes of sufficient size to support the loads placed on the frame. In the preferred embodiment, the tubes are round. However, square, rectangular, oval, or triangular tubes, or any tube that has a symmetrical cross-section, may be used. Also, in the preferred embodiment the tubes are steel, although any type of material, such as aluminum or carbon fiber, can be used as long as the material is structurally sufficient to handle the loads on the frame.

In the preferred embodiment, the plurality of tubes within the subframes 20L, 20R and the rear frame member 24 run parallel to each other for at least a portion of their length. In the preferred embodiment shown in FIGS. 1 and 2, the left and right subframes 20L, 20R and the rear frame member 24 each have at least two main tubes, and all of the tubes are of the same diameter, where the minimum diameter of the tubes is determined by structural analysis of the forces exerted on the frame. Such structural analysis can be performed by finite element analysis, and takes into account factors such as the power and weight of the engine used with the frame, the type of material used for the frame tubes, the distribution of the weight on the frame, the forces placed on the frame when the motorcycle is driven, and all such factors that one skilled in the art would consider in doing such an analysis. The subframes 20L, 20R may have additional support tubes disposed between tubes in the frame, as may be indicated to be necessary by structural analysis or as desired from a design standpoint, or as desired for use to mount various motorcycle parts and accessories such as seats, tanks, and a radiator. In addition, in the preferred embodiment, in the portions of the subframes 20L,20R and the rear frame member 24 where parallel tubes are closely situated to each other, the space between the tubes is the same for at least a portion of the total length that the parallel tubes are closely situated to each other, which allows the use of universal brackets throughout the frame.

The subframes 20L, 20R each have three distinct sections: the downtube section 26L, 26R, the horizontal section 28L, 28R, and the tail section 30L, 30R. The downtube section 26L, 26R is the forwardmost section of the subframes and is the section between the horizontal section 28L, 28R of each subframe and the steering neck tube 18. The forward end of each of the tubes that make up the left and right downtube sections 26L, 26R are affixed to the steering neck tube 18 using methods appropriate for the material used for the tubes, as known in the art. The angle and spacing at which the downtube section 26L, 26R tubes are affixed to the steering neck tube 18 is verified by structural analysis. Importantly, in one embodiment of the frame, the subframe tubes affixed to the steering neck tube must be able to withstand the forces placed on them without either the usual structural support toptube member found on motorcycles and other motorized vehicles that extends from the steering neck tube, over and perhaps attached to the engine, to a rearward section of the frame, or a structural member extending from steering neck tube to the engine. The engine is mounted to the horizontal section using appropriate engine mounts known in the art. In the preferred embodiment, a crosstube 50 is affixed between the lower tubes of the downtube sections 26L, 26R of the left and right subframes 20L, 20R.

From the steering neck tube 18, the tubes of the downtube sections 26L, 26R then extend downward, outward, and rearward to the horizontal section 28L, 28R of the subframes 20L, 20R. The horizontal section 28L, 28R of the subframes supports the engine 14 from the engine's lower portion. In the preferred embodiment, the steering neck tube and subframes are structurally capable of fully supporting the engine without the need for the usual toptube frame member found on motorcycles, which generally consists of a member connected at one end to the steering neck tube, which then travels over the engine, and which then connects on the other end to a rearward part of the motorcycle frame.

The tail sections 30L, 30R of the left and right subframes extend rearward and upward from the rearward ends of the horizontal sections. The tail sections 30L, 30R may also have portions that extend horizontally and rearward and downward and rearward. In the preferred embodiment, each of the subframes has a horizontally oriented S-shaped configuration when viewed from the side of the vehicle. The end of the tail sections 30L, 30R and the rear frame member 24 form a continuous rear frame at the back of the motorized vehicle.

FIGS. 3 through 18 depict the details of several embodiments of a movable universal bracket that is compatible with the motorized vehicle frame that is the subject of the present invention. In the preferred embodiment of the frame, all of the tubes that make up frame are the same diameter. Because of this, universal brackets that are designed to fit on frame tubes of that diameter can be installed at any point on the frame.

Each of the embodiments of the universal brackets has several features that are common to all of the brackets. Each of the brackets is comprised of two parts, where each part has at least one void the approximate size and shape of a fraction of the cross-section of the frame tubes, which allows the bracket to be installed on a single tube or adjacent to multiple tubes, and each part has at least one hole that is co-linear with a threaded hole in the other part of the universal bracket. Each of the co-linear holes may be threaded or unthreaded as required. This two-piece design allows the universal bracket to be easily installed around or adjacent to a frame tube in a secure fashion because the void formed by the two parts of the universal bracket is approximately the same shape as the frame tubes used in the motorized vehicle frame, providing the universal bracket with maximum surface contact with the frame tube. The co-linear hole(s) in each part of the bracket permit the two parts of the bracket to be securely affixed to each other and the frame.

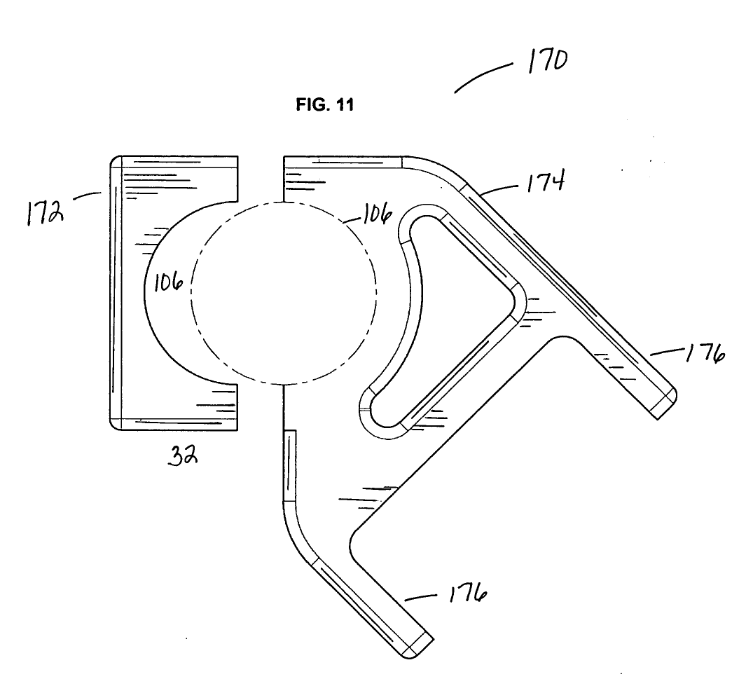

Also, in each embodiment, each part of the universal bracket may include threaded and/or unthreaded holes which, in combination with an appropriate sized fastener, can be used to mount parts such as footpegs, floorboards, radiators, turn signals, lights, brake pedals, and virtually any other part or accessory to the frame of the motorized vehicle. The holes may be drilled or otherwise formed in the universal brackets as needed, or the universal brackets may include such holes at regular locations on the parts of the universal bracket. As shown in FIGS. 11 through 18, the universal bracket can include additional mounting features such as tabs and flanges 176 to secure parts or accessories, which do not affect the usability of the bracket as long as the bracket has the necessary void to secure the bracket to a frame tube. The ability to place the bracket anywhere on the frame, in conjunction with the ability to mount parts to the mounting points provided on the bracket, effectively gives the user adjustability for all parts or accessories that are affixed to the frame using the universal brackets. For example, floorboards can be attached to the frame using universal brackets. Because the universal brackets can be attached to any point on the frame, the brackets effectively give the user adjustable floorboards.

In the embodiments of the universal bracket that are shown in FIGS. 3 through 6 and 9 through 18, each part of the brackets includes at least one void 106 approximately the size and shape one half the cross-sectional area of a frame tube. This design allows the universal bracket to be easily installed around a frame tube in a secure fashion because the void formed by the two parts of the universal bracket is approximately the same size and shape as the frame tubes used in the motorized vehicle frame, providing the universal bracket with virtually complete surface contact with the entire tube. In other embodiments, the void on the brackets may be in the shape of a fraction of an oval, square, rectangle, triangle, or any other symmetrical shape in order to allow the brackets to be used on non-round tubing.

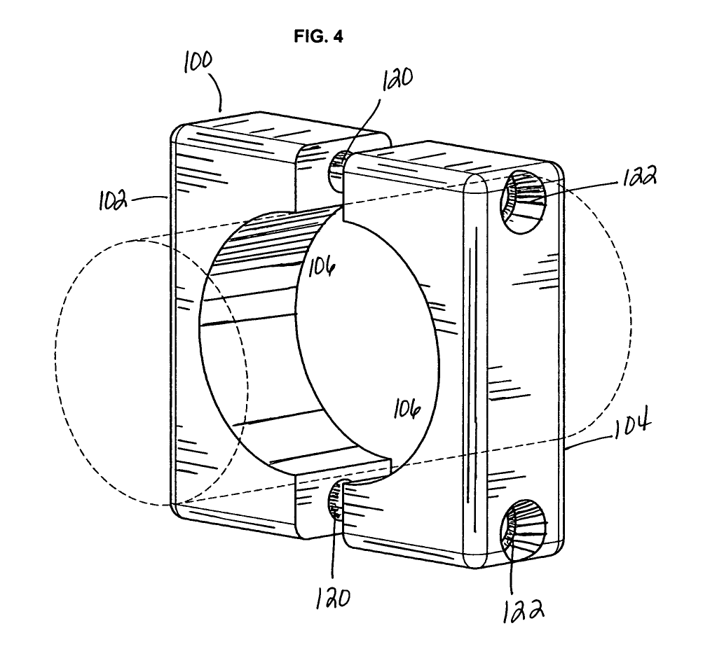

Specifically, the embodiment of the universal bracket 100 shown in FIGS. 3 and 4 includes two parts 102, 104. Each part has a void 106 approximately the size and shape of one half the cross-sectional area of a frame tube. In addition, the universal bracket 100 includes faces 110 that preferably are the same length as the uniform spacing used between closely situated parallel tubes on the motorized vehicle. This feature permits the universal bracket 100 to be placed around a tube 108 that is closely situated parallel to another tube, without the face 1 10 being obstructed by the parallel tube. The preferred embodiment of the universal bracket 100 includes co-linear holes 120, 122 in each part 102, 104 of the universal bracket 100, which allows the two parts 102, 104 to be affixed to each other with a suitable fastener. The fastener may be a bolt, a socket head cap screw, or any appropriate kind of fastener. In the preferred embodiment of the co-linear holes, one of the holes 122 includes a recessed area that is large enough to house the head of a fastener. This feature permits the top of the fastener head to be flush with or below the face of the universal bracket 100, adding to the aesthetic design of the bracket and preventing the fastener head from potentially being an obstruction to other nearby frame parts or members.

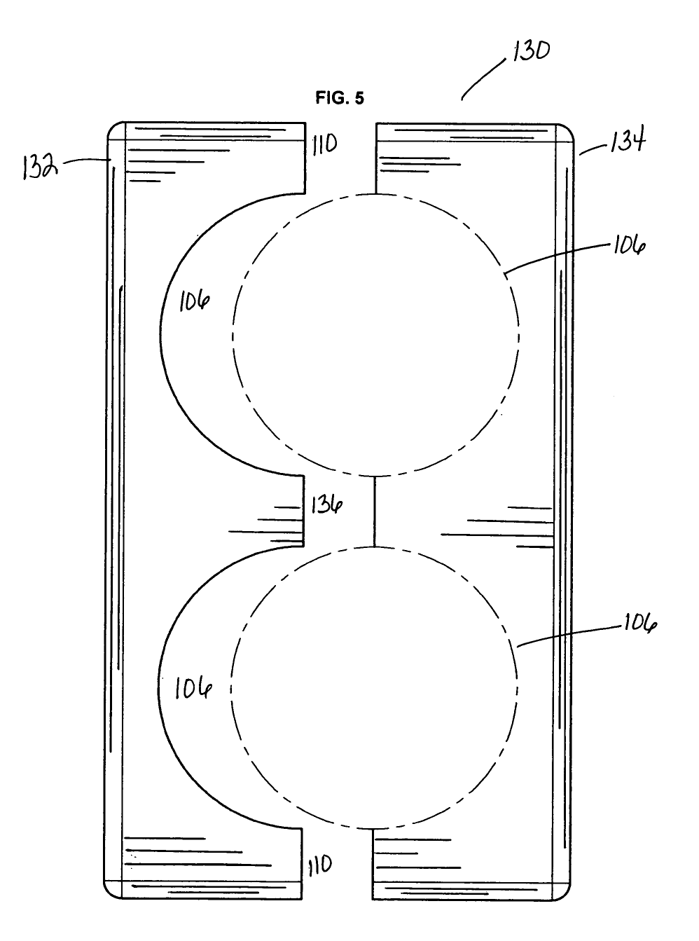

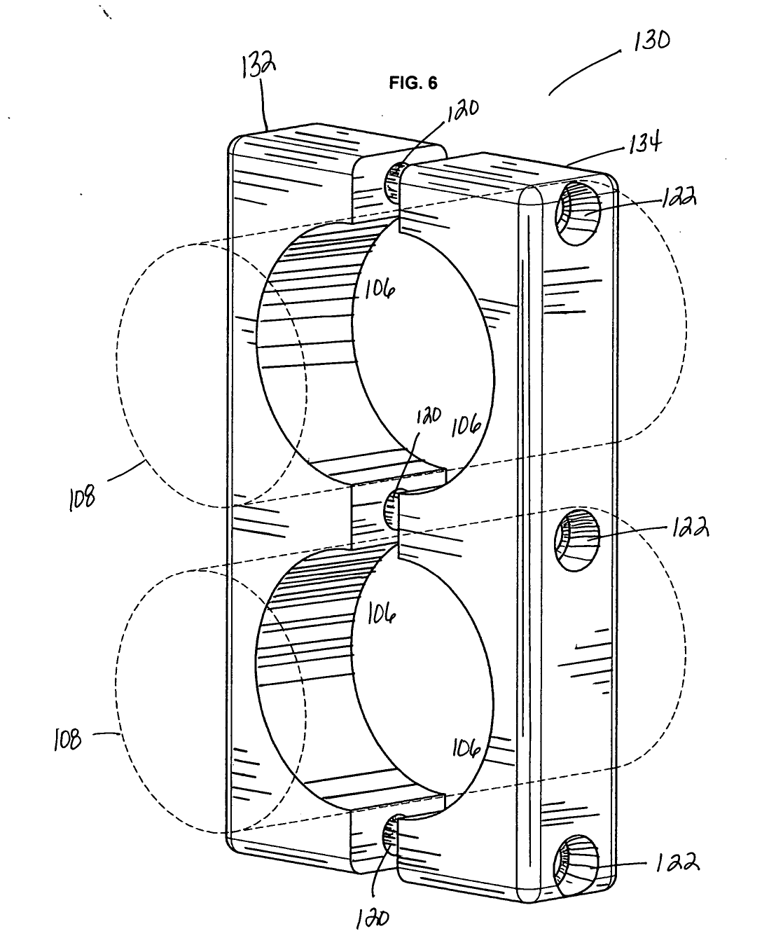

In the embodiment of the universal bracket 130 shown in FIGS. 5 and 6, each part 132, 134 includes two voids 106 approximately the size and shape of one half the cross-sectional area of a frame tube. Like all the universal brackets, the embodiment of the universal bracket 130 shown in FIGS. 5 and 6 includes co-linear holes 120, 122 in each part 102, 104 of the universal bracket 130, which allows the two parts 132, 134 to be affixed to each other with a suitable fastener. The universal bracket 130 includes faces 110 that preferably are the same length as the uniform spacing used between closely situated parallel tubes on the motorized vehicle. Face 136 of the universal bracket 130 must be the same length as the uniform spacing used between closely situated parallel tubes on the motorized vehicle so that the bracket can be used on closely situated parallel tubes. Additional embodiments of the universal brackets of FIGS. 3 through 6 can be designed that include any number of voids, as long as the size of the tubes and the spacing between closely situated parallel tubes is uniform.

The universal bracket 130 of FIGS. 5 and 6 is also used to affix a master cylinder for the motorized vehicle's hydraulic brake system to the frame. The master cylinder is constructed from bar stock with the same cross-sectional size and shape as the tubing used throughout the preferred embodiment of the frame. The master cylinder bar stock may be made from the same material as the tubing used for the frame, or it may be made from other materials such as aluminum. Because the master cylinder has the same cross-sectional size and shape as a frame tube it can be affixed to the frame using universal brackets, which adds to the aesthetic appeal of the motorized vehicle. As will be known to one skilled in the art, the master cylinder material has to be able to resist degradation by brake fluid, which is highly corrosive. In addition, the master cylinder will include all parts normally found in master cylinders, such as a reservoir capable of holding brake fluid and appropriate diaphragms to enable hydraulic pressure to be contained within the system, and appropriate parts (such as a plunger) necessary to create hydraulic pressure in response to the actuation of a brake lever or pedal by the driver of the motorized vehicle. In addition, the master cylinder will have appropriate brake lines from the master cylinder to the brake lever or pedal, as well as appropriate fittings such as banjo bolts to connect the brake lines to the master cylinder, brake lever, or pedal. In one embodiment, the brake lines may be the type usually used for motorcycles, which are usually constructed of rubber tubing or rubber tubing with stainless steel braiding around the rubber tubing. In another embodiment, the brake fluid may be routed through a combination of motorcycle brake lines and frame tubes of the motorized vehicle frame. As will be understood by one with ordinary skill in the art, if the frame tube is used to rout brake fluid, a sufficient capacity of brake fluid is used to maintain adequate hydraulic pressure within the brake system. In addition, appropriate fittings to connect motorcycle brake lines to the frame tube are used to maintain the pressure within the hydraulic brake system.

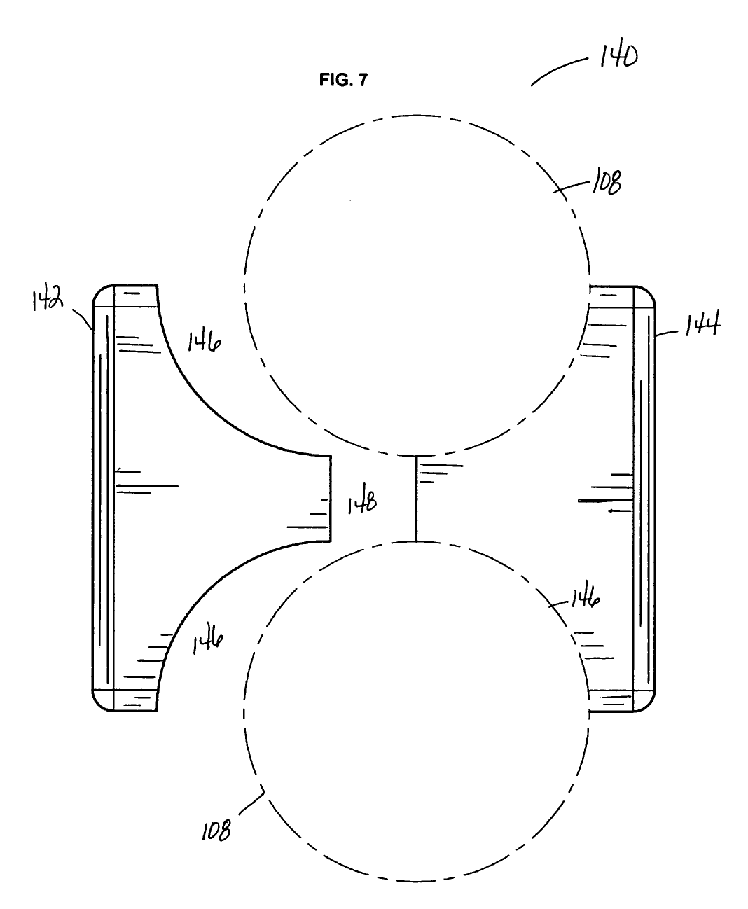

FIGS. 7 through 10 depict other embodiments of the universal bracket where each part of the universal bracket includes at least one void 146 that is approximately a quarter of the size and shape of the cross-sectional area of a frame tube. When the two parts of the bracket are combined, the approximately quarter size voids in each bracket combine to form a void approximately the size of half of the cross-sectional area of a frame tube. This embodiment of the universal bracket may be preferable where universal brackets that fully captivate a frame tube would be too large for the intended application or where there are obstructions that do not allow the use of such brackets.

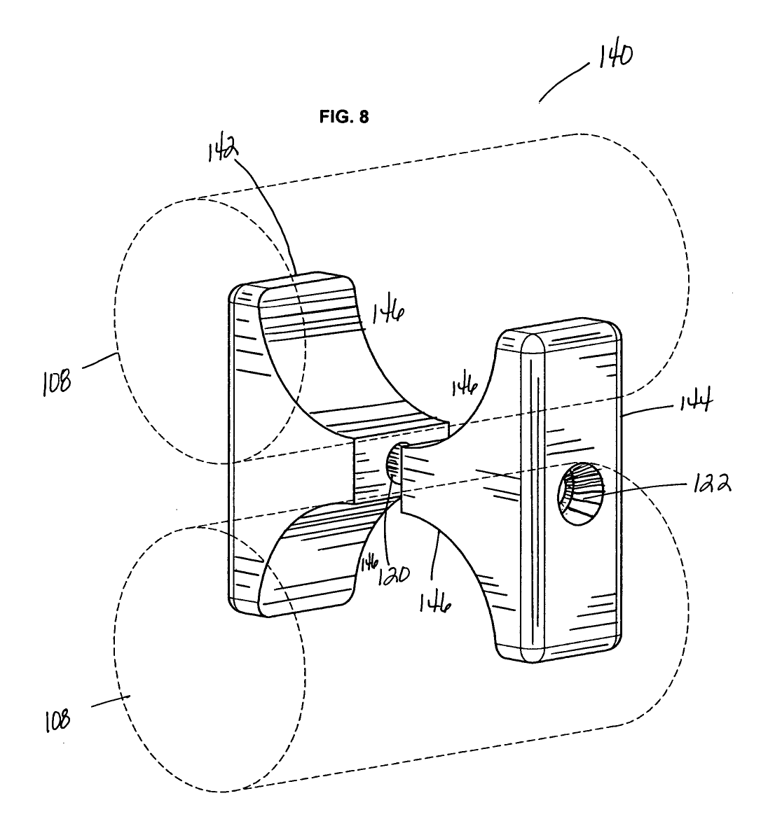

Specifically, FIGS. 7 and 8 depict an embodiment of the universal bracket 140 that includes two parts 142, 144. Each part has a void 146 approximately one quarter the cross-sectional area of a frame tube. In addition, the universal bracket 140 includes a face 148 that is the same length as the uniform spacing used between closely situated parallel tubes on the motorized vehicle. This feature permits the universal bracket 140 to be used between closely situated parallel tubes. The preferred embodiment of the universal bracket 140 includes a co-linear hole 120, 122 in each part 142, 144 of the universal bracket 140, which allows the two parts 142, 144 to be affixed to each other with a suitable fastener. In the preferred embodiment of the co-linear holes, one of the holes 122 includes a recessed area that is large enough to house the head of a fastener. This feature permits the top of the fastener head to be flush with or below the face of the universal bracket 140, adding to the aesthetic design of the bracket and preventing the fastener head from potentially being an obstruction to other nearby frame parts or members.

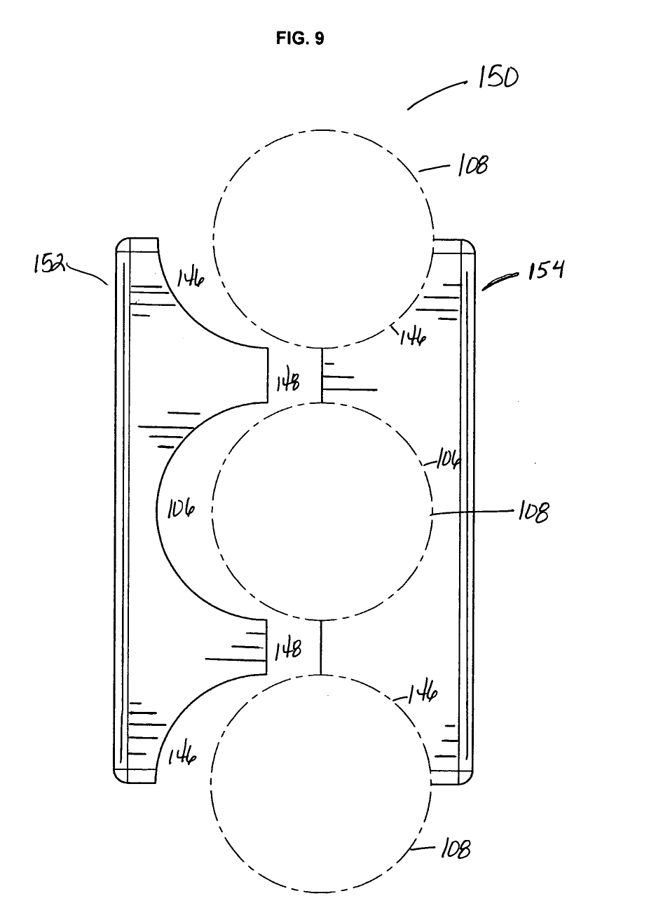

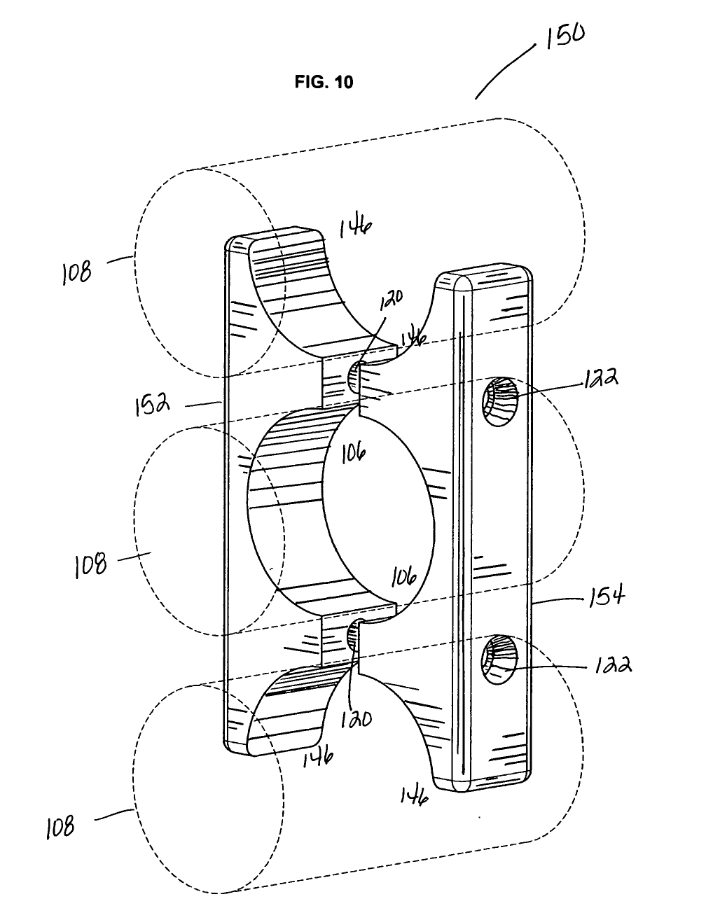

FIGS. 9 and 10 depict an embodiment of the universal bracket 150 in which each of the parts 152, 154 includes two voids 146 approximately the size and shape of one quarter the cross-sectional area of a frame tube, and one void 106 approximately the size and shape of one half the cross-sectional area of a frame tube. Like all the universal brackets, the embodiment of the universal bracket 150 shown in FIGS. 9 and 10 includes co-linear holes 120, 122 in each part 152, 154 of the universal bracket 150, which allows the two parts 152, 154 to be affixed to each other with a suitable fastener. The universal bracket 150 includes faces 148 that are the same length as the uniform spacing used between closely situated parallel tubes on the motorized vehicle, which allow the universal bracket 150 to be used between closely situated parallel tubes. Additional embodiments of the universal brackets of FIGS. 9 and 10 can be designed that include any number and size of quarter and half voids, as long as the size of the tubes and the spacing between closely situated parallel tubes is uniform.

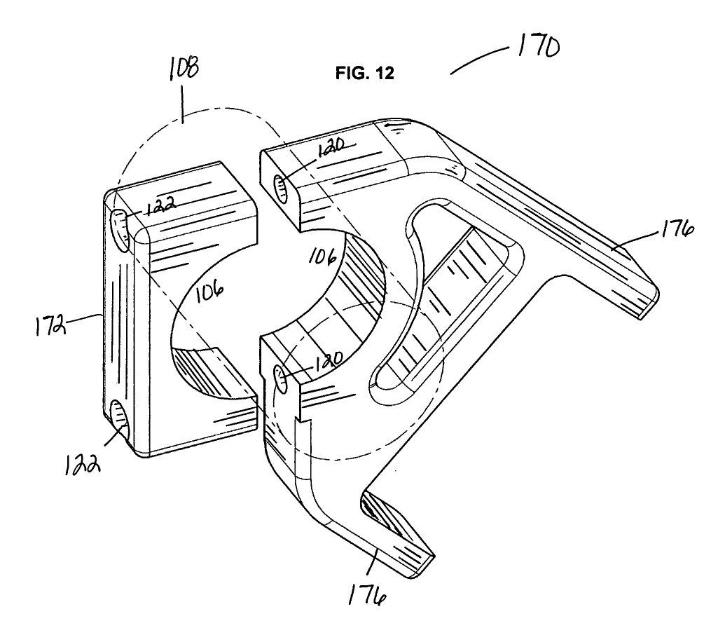

The embodiment of the universal bracket 170 shown in FIGS. 11 and 12 is used to mount the radiator 60 to the rearmost crosstube 32 between the left and right subframes. It includes two parts 172, 174. Each part has a void 106 approximately one half the cross-sectional area of a frame tube. In addition, part 174 includes flanges 176 that are used to mount the radiator to the universal bracket 170, and co-linear holes 120, 122 in each part 172, 174 of the universal bracket 170, which allows the two parts 172, 174 to be affixed to each other with a suitable fastener. This universal bracket 170 depicts just one possible embodiment of a bracket with mounting flanges. Additional embodiments of the universal brackets can be designed that include any size, shape, and number of flanges, as necessary.

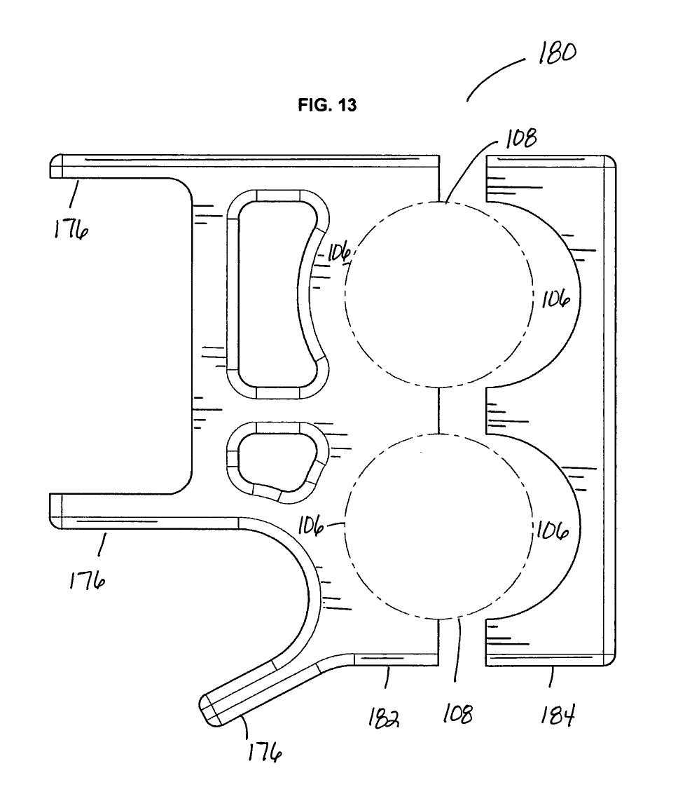

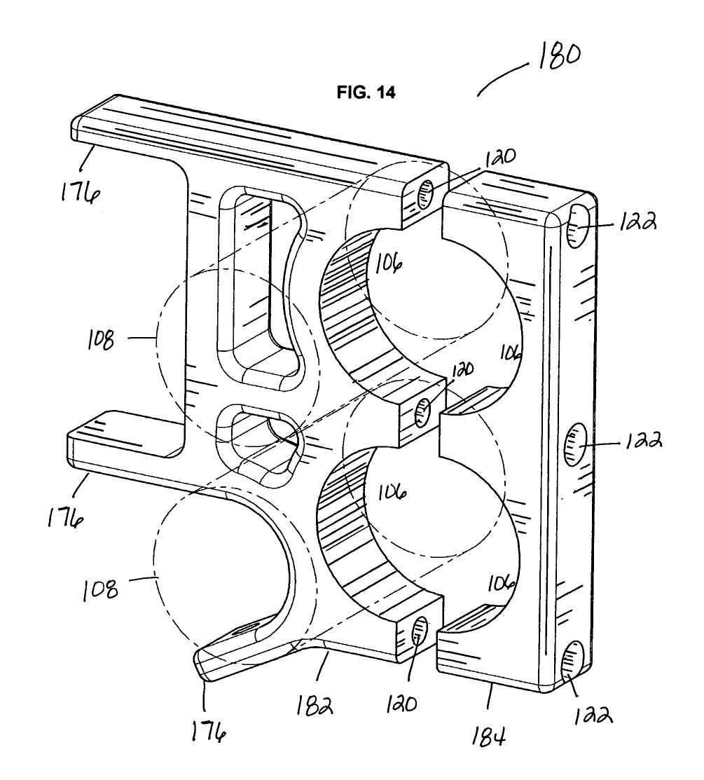

FIGS. 13 and 14 depict another embodiment of the universal bracket 180 that includes additional mounting flanges 176, which are used to mount the radiator 60 to the rear frame member 24. It includes two parts 182, 184. Each part has two voids 106 approximately the size and shape of one half the cross-sectional area of a frame tube. In addition, part 182 includes flanges 176 that are used to mount the radiator to the universal bracket 180, and co-linear holes 120, 122 in each part 182, 184 of the universal bracket 180, which allows the two parts 182, 184 to be affixed to each other with a suitable fastener. This universal bracket 180 depicts another possible embodiment of a bracket with mounting flanges. Additional embodiments of the universal brackets can be designed that include any size, shape, and number of flanges, as necessary.

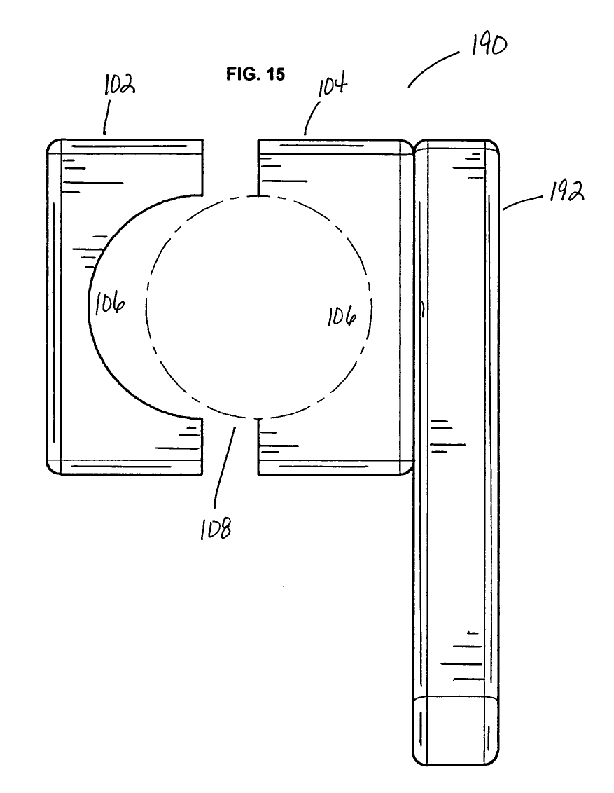

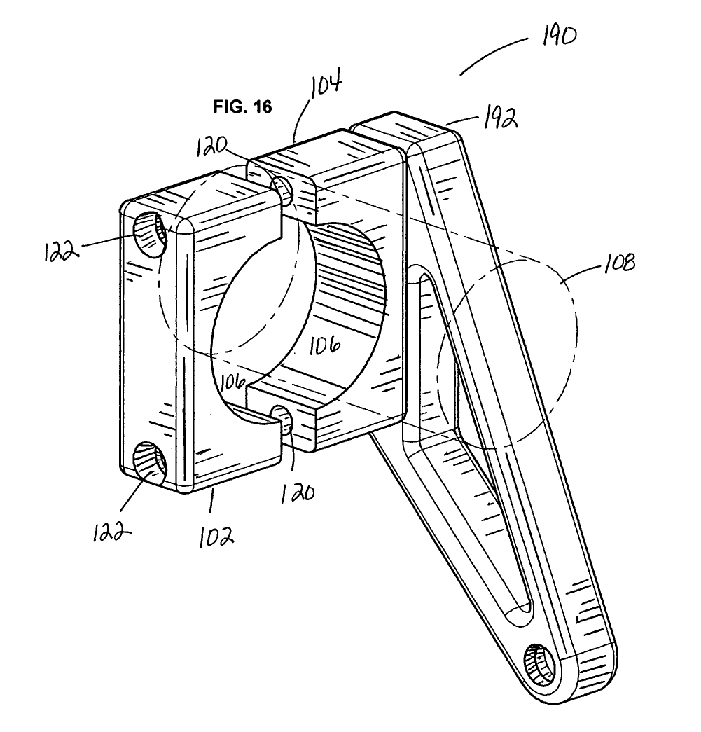

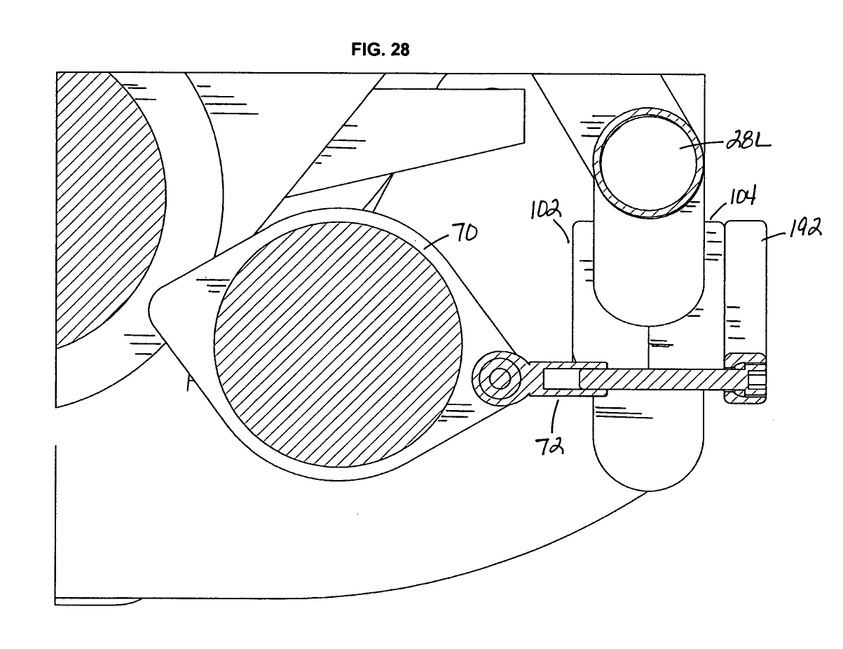

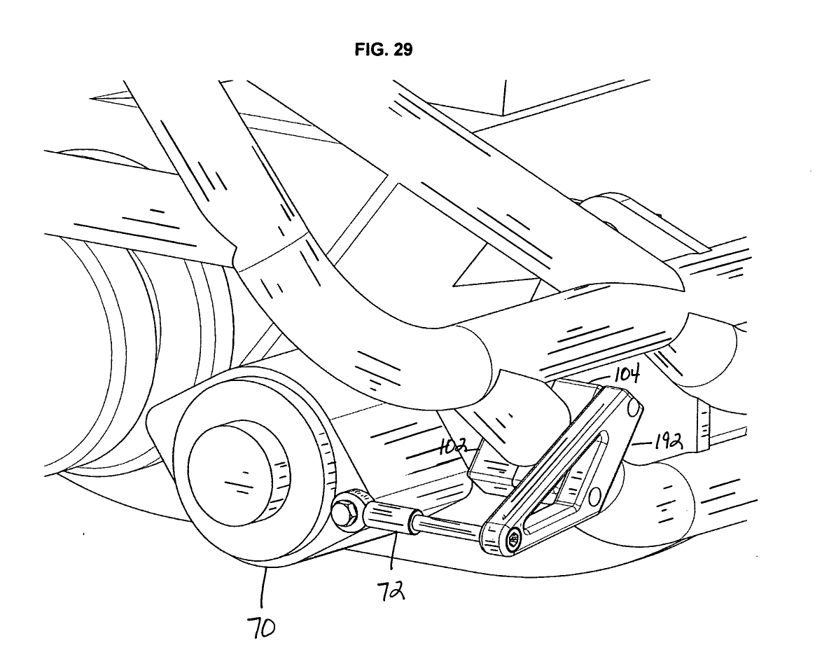

Another embodiment of the universal bracket 190 is shown in FIGS. 15 and 16. This embodiment essentially consists of the universal bracket of FIGS. 3 and 4, to which a triangular shaped member 192 is affixed. The triangular shaped member 192 is used within the alternator mounting system shown in FIGS. 28 and 29. As with all other embodiments of the universal brackets, universal bracket 190 include co-linear holes 120, 122 in each part 102, 104 of the universal bracket 190, which allows the two parts 102, 104 to be affixed to each other with a suitable fastener.

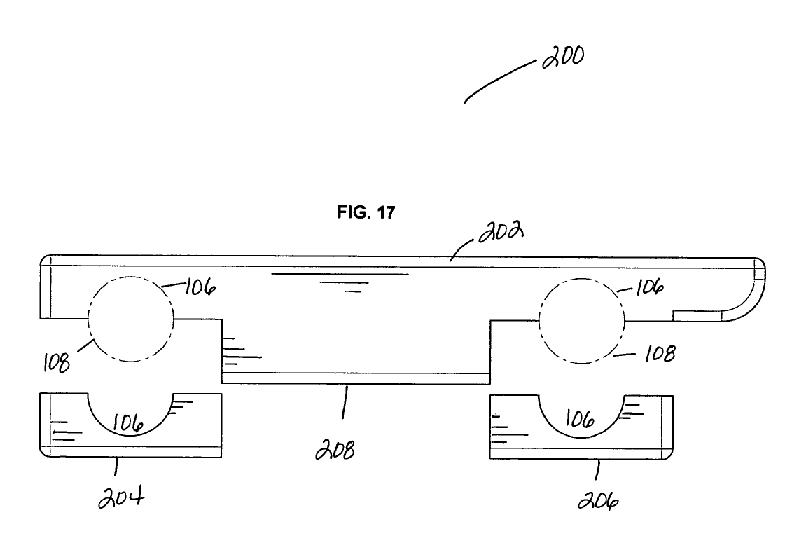

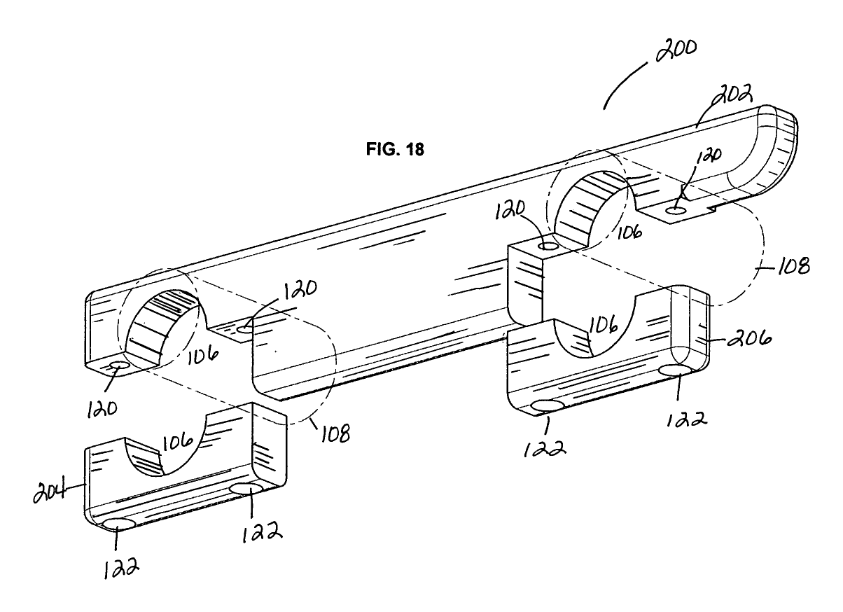

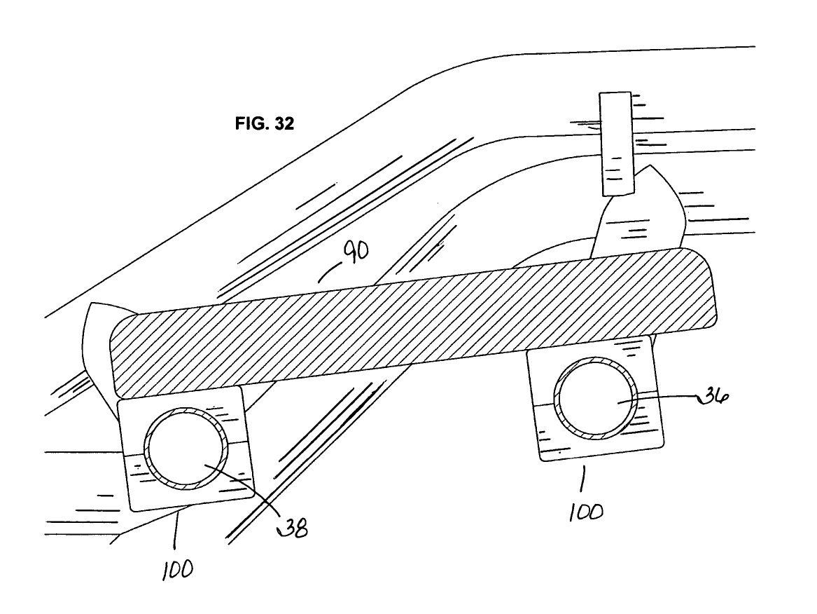

FIGS. 17 and 18 depict one other embodiment of the universal bracket 200 which includes three parts 202, 204, 206. Part 202 includes two voids 106 approximately the size and shape of one half the cross-sectional area of a frame tube. Parts 204 and 206 each include one void the approximate size and shape of one half the cross-sectional area of a frame tube. Like all the universal brackets, the embodiment of the universal bracket 200 shown in FIGS. 5 and 6 includes co-linear holes 120, 122 in each part 202, 204 of the universal bracket 200, which allows the two parts 202, 204 to be affixed to each other with a suitable fastener. Importantly, the universal bracket 200 is designed to be used on parallel tubes that are not closely situated. The length of face 208 is determined by the distance between the crosstubes to which the bracket is being mounted. In the embodiment shown in FIGS. 17 and 18, the universal brackets are used to attach a passenger's seat 90 to crosstubes 36 and 38, as is also shown in FIG. 32. The passenger's seat is affixed to part 202, using appropriate mounting holes in part 202.

Significantly, another advantage of the universal brackets, and particularly the embodiments of the brackets that are placed between or around two closely situated frame tubes (FIGS. 5 through 10), is that when they are affixed to the frame they act as structural members that add to the strength of the entire frame. The addition of a universal bracket to a known stress point that has been calculated through structural analysis has been shown to increase the frame's ability to handle the force on that point of the frame. This is particularly desirable where engine modifications are made that increase the power of an engine and structural analysis based upon the new power ratings depicts increased stress at various points on the frame. Structural analysis has shown that the addition of the universal brackets can increase the strength of those stress points and possibly prevent catastrophic failure of the tubing at those points. In the preferred embodiment, the brackets are made from 6061-T6 aluminum. The brackets may be made of a different material as desired, including stronger material to compensate for increased stress points on the frame.

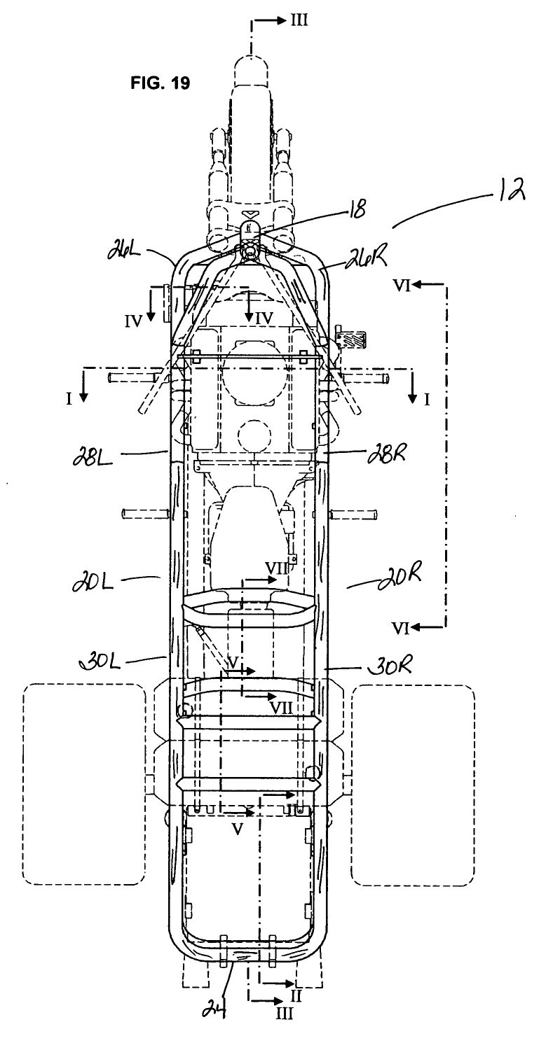

FIG. 19 depicts a top plan view of the motorized vehicle frame. The steering neck tube 18, is adjacent to the downtube sections 26L, 26R of the left and right subframes 20L, 20R. Rearward and adjacent to the downtube sections is the horizontal sections 28L, 28R of the left and right subframes 20L, 20R. Rearward and adjacent to the horizontal sections is the tail sections 30L, 30R of the left and right subframes. The rear frame member 24 is adjacent to the rearward ends of the tail sections 30L, 30R.

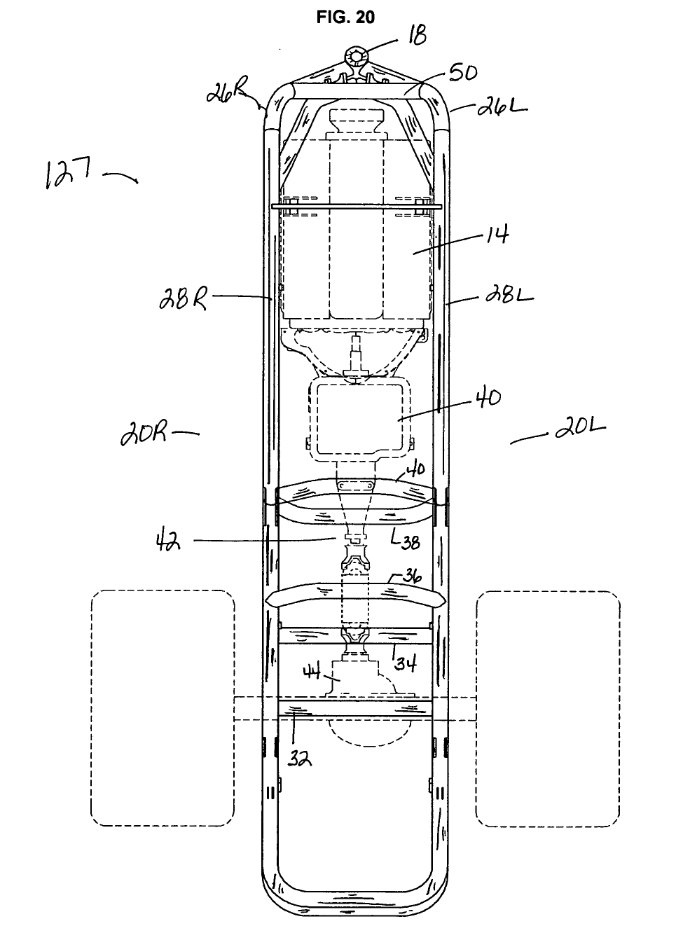

FIG. 20 depicts a bottom view of a motorized vehicle frame which includes its powertrain parts. The powertrain consists of a transmission 40 rearward and adjacent to the engine, a driveshaft 42 rearward and adjacent to the transmission, and a differential 44 rearward and adjacent to the driveshaft. In the preferred embodiment the transmission 40 is a conventional automobile transmission which is automatic. The transmission may also be either a manual or automatic transmission, and can also be a non-automobile transmission. In the preferred embodiment of the frame, the length of the frame is substantially similar to the length required for the powertrain components. Preferably, powertrain components are chosen that are not unnecessarily long longitudinally, which allows the drivetrain to be shorter, which permits the frame to be shorter. This embodiment has the preferred characteristic of having a vehicle that has a short wheelbase, which is more maneuverable than a vehicle with a long wheelbase.

FIG. 20 also depicts the various crosstubes used in the preferred embodiment of the frame. The rearmost crosstube 32 is used to mount the radiator 60. Crosstubes 32 and 34 are used to mount the fuel tanks 16. Crosstubes 36 and 38 are used to mount the passenger's seat 90. Crosstube 40 is used to support the transmission 40.

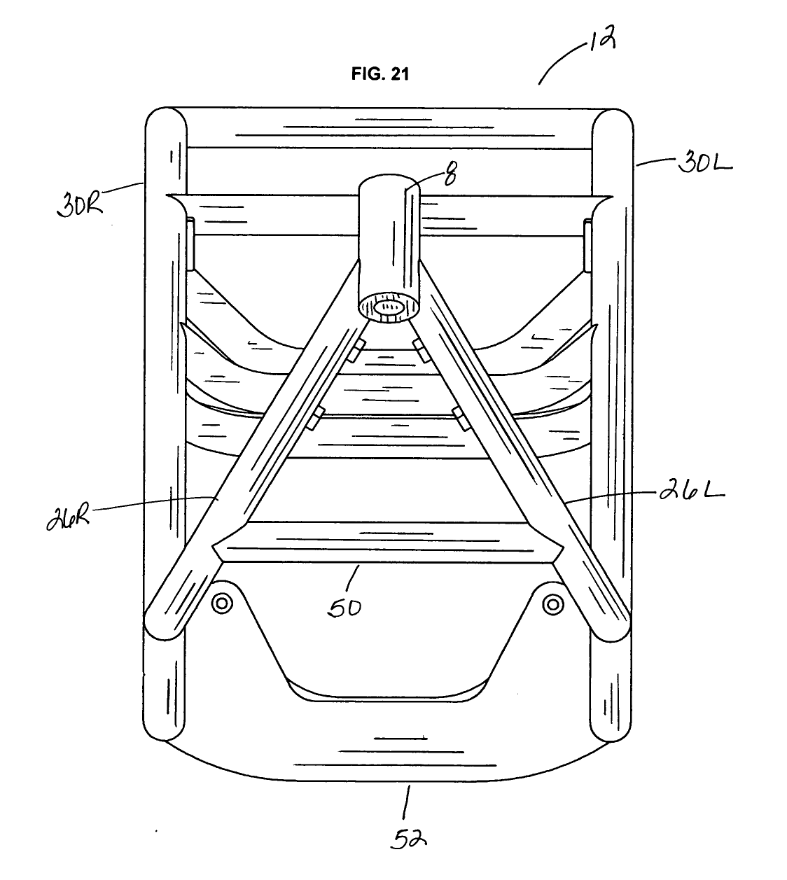

FIG. 21 depicts a front elevation view of the motorized vehicle frame. In the preferred embodiment of the frame, a crosstube 50 is affixed between lower tubes of the downtube sections 26L, 26R of the left and right subframes. In addition, bracket 52 is affixed between the left and right subframes to help support the engine from the bottom of the engine.

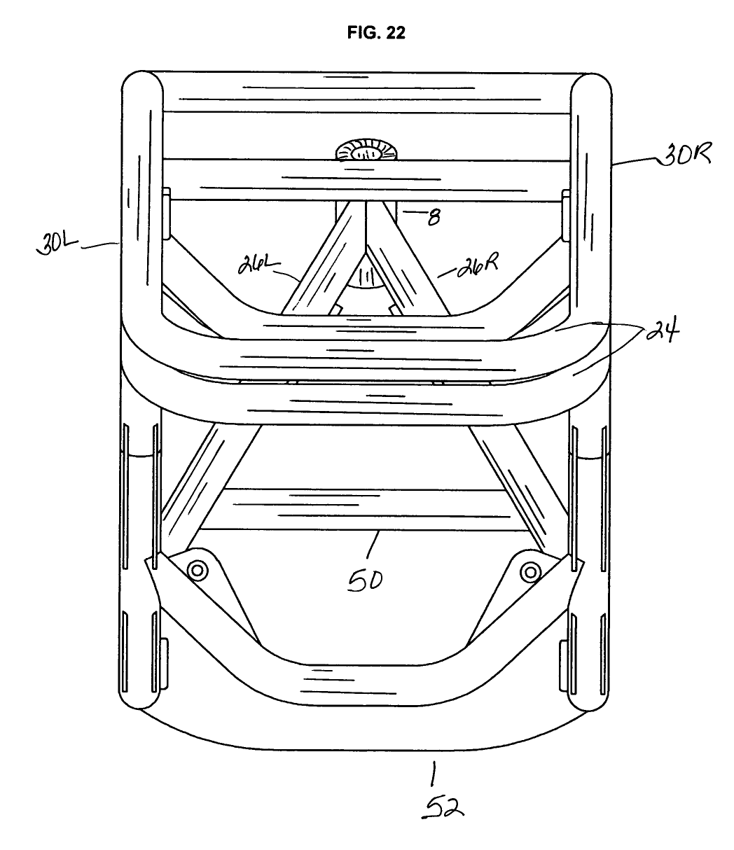

FIG. 22 depicts a rear elevation view of the motorized vehicle frame. The left and right sides of the rear frame member 24 extend to the tail sections 30L, 30R of the left and right subframes. The tail sections of the left and right subframes may include crosstubes affixed between tubes of the left and right tail sections. In the preferred embodiment, a radiator 60 is mounted within the space formed by the rearmost crosstube 32 on the tail sections 30L, 30R of the left and right subframes, the left and right subframes 20L, 20R, and the rear frame member 24, using the universal brackets of FIGS. 11 and 12.

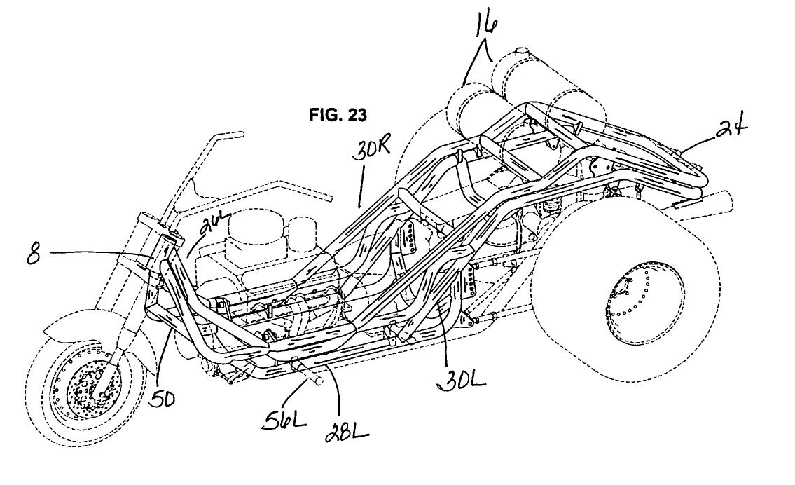

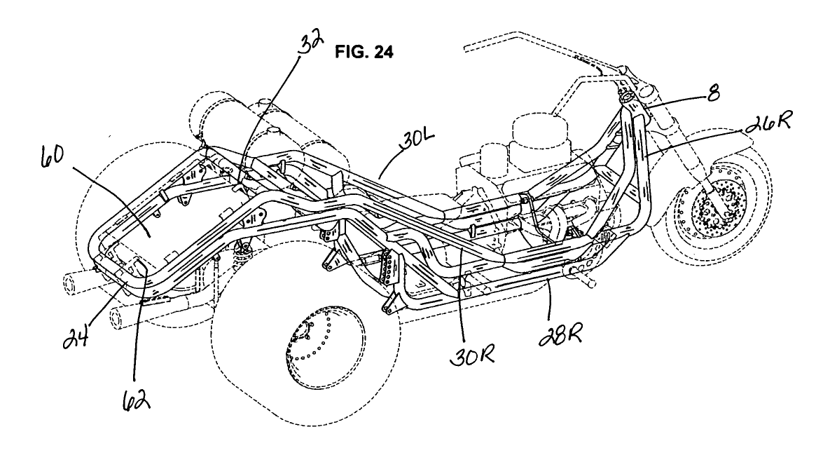

FIGS. 23 and 24 depict front and rear perspective views of the motorized vehicle frame. FIG. 23 depicts footpegs attached to the horizontal section of the subframe. The driver's footpegs 56L, 56R are movably attached to the frame using universal brackets. In the preferred embodiment, for one of the footpegs a brake lever is installed co-axially with the fastener used to mount the footpeg to the universal bracket. The passenger's footpegs are also movably attached to the subframes using appropriate universal brackets depending on the desired location of the passenger's footpegs. FIG. 24 depicts the space formed by a tail crosstube 32, the left and right subframes 20L, 20R, and the rear frame member 24 in which the radiator 60 is installed. The radiator 60 is attached to the frame using the universal brackets of FIGS. 11 and 12.

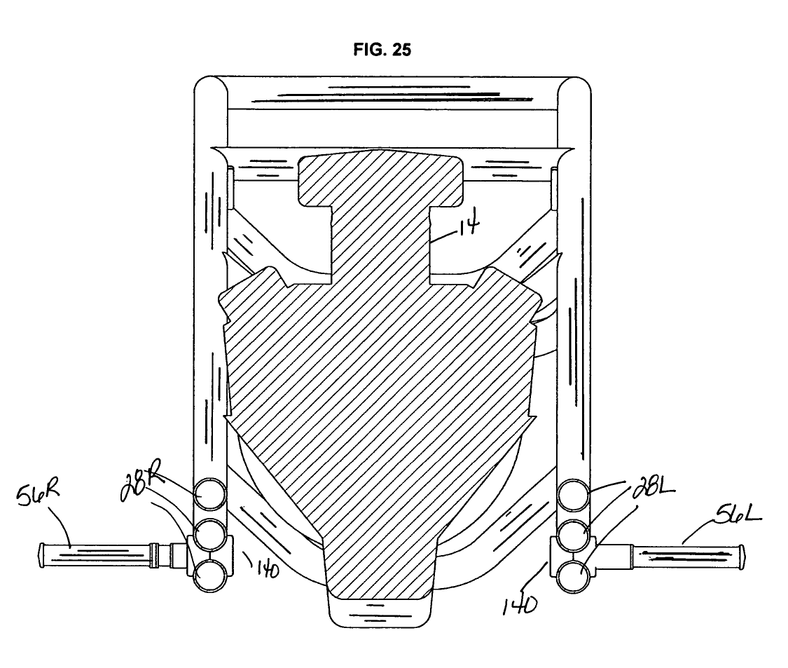

FIG. 25 depicts a sectional view taken along line I-I in FIG. 3. In the preferred embodiment of the frame, footpegs 56L, 56R for the driver's feet are movably mounted to the frame using universal brackets. The footpegs 56L, 56R are affixed to the tubes of the horizontal sections 28L, 28R of the left and right subframes. Because the brackets can be mounted anywhere along the horizontal section, a rider can adjust the footpegs as necessary to maximize the comfort and utility of the footpegs. In the alternative, a rider can mount floorboards to the frame using universal brackets, instead of footpegs.

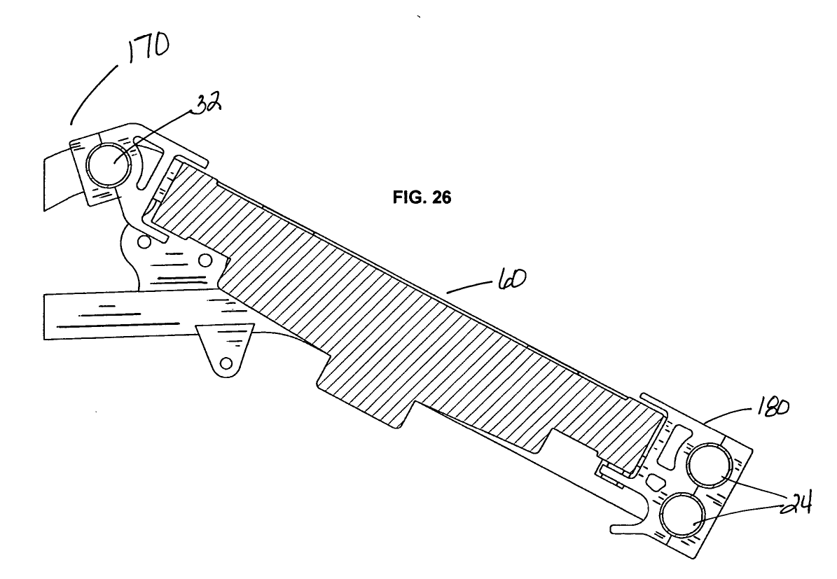

FIG. 26 depicts a sectional view taken along line II-II in FIG. 3. The radiator 60 is affixed within the space formed by the tail sections 30L, 30R of the subframes, the rear frame member 24, and the rearmost crosstube 32, using the universal brackets of FIGS. 11 through 14. As shown in FIGS. 11 through 14, the universal brackets include two parts. One part of each of the universal brackets used to mount the radiator includes additional flanges which are used to mount the radiator 60.

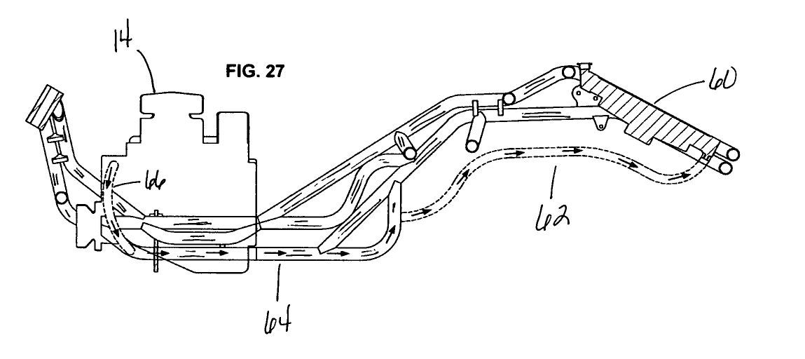

FIG. 27 depicts a sectional view taken along line III-III in FIG. 19, and depicts the routing of coolant from the engine 14 to the radiator 60, via conduits and a frame tube. Conduit 66 carries the coolant from the engine's waterpump to the frame tube 64. Frame tube 64 carries the coolant rearward. Conduit 62 then carries the coolant from the frame tube 64 to the radiator. The conduit is of a type used to carry coolant. The fitting used to attach the conduit to the frame is of a type suitable for that purpose in light of the materials used for the frame tubes and the size of the conduit and frame tube. FIG. 27 depicts the routing of the coolant in the direction of the radiator from the engine. A similar configuration is used on the opposite side of the frame to rout the coolant in the direction of the engine from the radiator, which creates a complete cooling system loop from engine to radiator, then from the radiator to the engine, via conduits and frame tubes.

FIG. 28 depicts a sectional view taken along line IV-IV in FIG. 3 and FIG. 29 depicts a perspective view of the alternator 70 and the alternator mounting configuration. The alternator 70 is movably affixed to the engine 14 at one point of the alternator. The alternator 70 is also movably affixed to one end of a strut 72 at another point of the alternator 70. The other end of the strut 72 is affixed to mounting points on the universal bracket 190 shown in FIGS. 15 and 16, and the universal bracket is affixed to the frame. Use of a strut 72 to movably affix the alternator to the frame allows the alternator 70 to be moved as necessary to obtain the proper tension in the alternator belt. In the preferred embodiment, the triangular member 192 of universal bracket 190 has a mounting hole that has a semi-circular cross-sectional shape for a portion of the total depth of the mounting hole and cylindrical shape for the portion of the mounting hole closest to the alternator. A fastener with a threaded end and a washer with a semi-circular cross-sectional shape are disposed within the mounting hole, and the threaded end of the fastener extends beyond the bottom of the mounting hole, and is threaded to the universal strut, which has an appropriate threaded hole to receive the fastener. The cylindrical portion of the mounting hole has a larger diameter than the fastener. This feature, in combination with the semi-circular portion of the mounting hole and the semi-circular washer, allow the fastener to swivel within the mounting hole. The ability to swivel the fastener greatly facilitates the installation of the strut for the alternator.

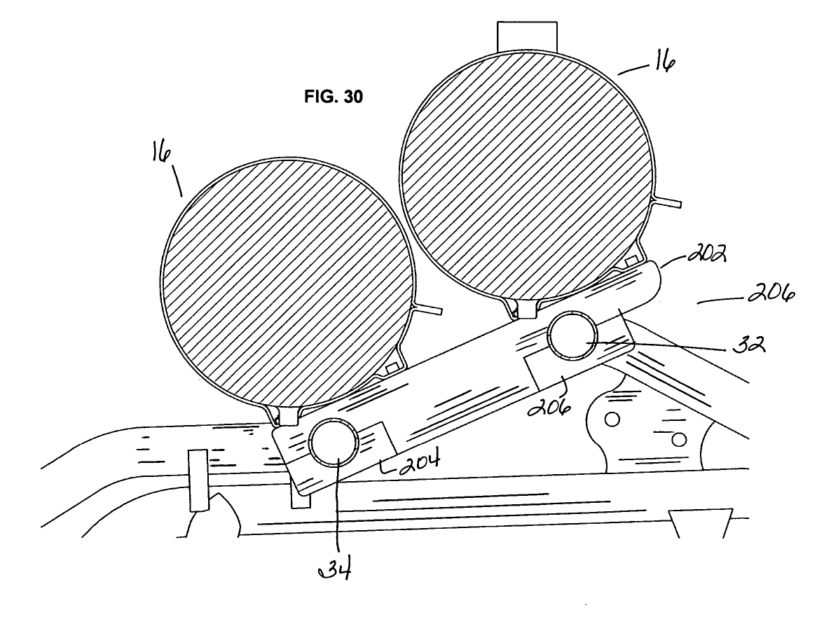

FIG. 30 depicts a sectional view taken along line V-V in FIG. 3. In the preferred embodiment, the frame carries two fuel tanks 16. Each fuel tank 16 is affixed to crosstubes 32, 34 on the tail section of the frame using the universal brackets of FIGS. 17 and 18. Suitable straps are affixed to mounting points on part 202 of the universal brackets and are wrapped around each tank 16, fixing the tanks 16 into place. Parts 204 and 206 of the universal brackets secure the universal bracket to the crosstubes 32, 34.

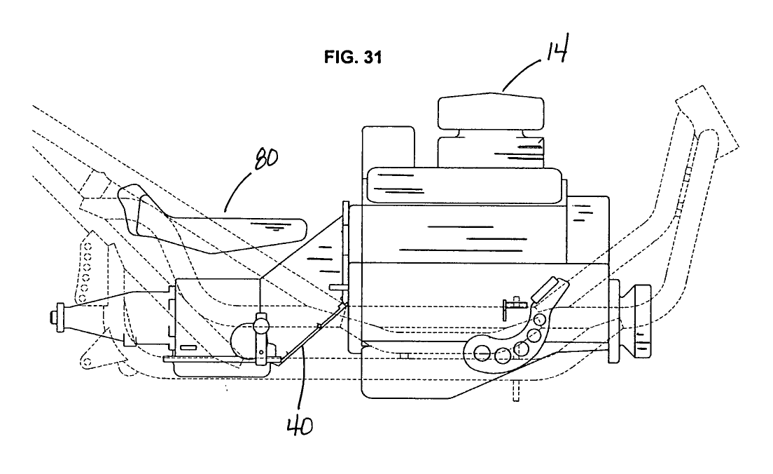

FIG. 31 depicts a sectional view taken along line VI-VI in FIG. 3. A suitable metal cover (not shown) is installed over the transmission and driveshaft, and is affixed to the frame using suitable brackets and supports. Preferably, the metal cover is protective in nature and is a scattershield or split metal tubing that will help protect a rider in case of driveshaft or transmission failure. A driver's seat 80 is affixed to the cover. Significantly, the driver's seat 80 is positioned minimally rearward of the engine 14 so that when the driver is riding the motorcycle, the driver's legs are disposed to the sides of the engine, which increases the visceral appeal of riding the motorcycle.

FIG. 32 depicts a passenger's seat 90 installed rearward of the driver's seat 80, with adequate clearance so that the passenger's legs are not making contact with the driver's back. In the preferred embodiment, the passenger seat 90 is affixed to crosstubes 36, 38 using universal brackets 100 affixed between the tail sections of the left and right subframes.

Although the invention has been described in terms of various specific embodiments, those skilled in the art will recognize that the invention can be practiced with modification within the spirit and scope of the claims.

1. A frame for a motorized vehicle that is to be powered by a conventional automobile engine block supported in the frame, comprising:
a steering neck tube;
a support for the engine block which is formed by a left and right subframes extending rearward and longitudinally of said steering neck tube and on respective sides of said steering neck tube, then extending inward to form a continuous rear frame member;
each of said left and right subframes having a downtube section that is affixed to said steering neck tube and which then extends outward, downward, and rearward from said head tube;
each of said left and right subframes having a horizontal section adjacent to the rearward end of said downtube section, each said horizontal section extending rearward and longitudinally; and
each of said left and right subframes having a tail section adjacent to the rearward end of said horizontal sections, each said tail section having a portion extending upward and rearward of said horizontal section.

2. The motorized vehicle frame of claim 1 wherein each of said left and right subframes is comprised of a plurality of tubes.

3. The motorized vehicle frame of claim 2 wherein the tubes in said left subframe are parallel to each other for at least a portion of their total length and the tubes in said right subframe are parallel to each other for at least a portion of their total length.

4. The motorized vehicle frame of claims 3 wherein said rear frame member is comprised of a plurality of tubes.

5. The motorized vehicle frame of claim 4 wherein each of the tubes in said left and right subframes and said rear frame member has the same cross-sectional size and shape.

6. The motorized vehicle frame of claim 5 wherein the space between parallel tubes within the left subframe, the right subframe, and the rear frame members is uniform for at least a portion of the total length that any such tubes within the subframes and rear member are parallel.

7. The motorized vehicle frame of claim 5 further comprising
a universal bracket capable of being movably affixed to the frame;
said universal bracket having two parts, each part having at least one void the size and shape of a fraction of the cross-section of a frame tube;
each of said parts of said universal bracket having at least one co-linear hole which allow said parts to be affixed together adjacent to a frame tube; and
said universal bracket having at least one mounting hole for mounting motorcycle parts or accessories to said universal bracket.

8. The motorized vehicle frame of claim 7 wherein the void in each part of said universal bracket is the approximate size and shape of one half of the cross-section of a frame tube.

9. The motorized vehicle frame of claim 7 wherein the void in each part of said universal bracket is the approximate size and shape of one quarter of the cross-section of a frame tube.

10. The universal bracket of claim 7 wherein said bracket is constructed of material sufficient to allow said bracket to act as a structural member when said bracket is affixed adjacent to at least two parallel tubes in said frame.

11. The motorized vehicle frame of claim 7 further comprising a plurality of footpegs, wherein each of said footpegs is affixed to a universal bracket and each said universal bracket is movably affixed to a subframe tube.

12. The motorized vehicle frame of claim 11, further comprising a brake pedal, wherein said brake pedal is affixed co-axially with one of said footpegs to a universal bracket.

13. The motorized vehicle frame of claim 7 further comprising a plurality of floorboards, wherein each said floorboard is affixed to a universal bracket and said universal bracket is movably affixed to a subframe tube.

14. The motorized vehicle frame of claim 1 further including a driver' seat installed rearward of said engine.

15. The motorized vehicle frame of claim 14 wherein said driver's seat is installed minimally rearward of said engine causing the driver's legs to be disposed to the sides of the engine when sitting in said driver's seat.

16. The motorized vehicle frame of claims 15 wherein the seating surface of said driver's seat is at the same height or below the top of the camshaft cover of said engine.

17. The motorized vehicle frame of claim 1 further comprising a conventional automobile transmission longitudinally rearward and adjacent to said engine, a driveshaft longitudinally rearward and adjacent to said transmission, and a differential longitudinally rearward and adjacent to said driveshaft, and wheels lateral to said differential and connected to said differential by an axle movably connected to said differential.

18. The motorized vehicle frame of claim 7, further comprising a plurality of crosstubes, each of said crosstubes-affixed on one end to a tube of said left subframe and affixed on the other end to a tube of said right subframe.

19. The motorized vehicle frame of claim 18, further comprising a passenger's seat affixed to at least one of said plurality of crosstubes.

20. The motorized vehicle frame of claim 19, wherein said passenger's seat is affixed to at least one of said universal brackets and said universal bracket is movably affixed to at least one of said plurality of crosstubes.

21. The motorized vehicle frame of claim 18, further comprising a fuel tank affixed to at least one of said plurality of crosstubes.

22. The motorized vehicle frame of claim 21, wherein said fuel tank is affixed to at least one of said universal brackets and said universal bracket is movably affixed to at least one of said plurality of crosstubes.

23. The motorized vehicle frame of claim 5, further comprising a conventional automobile engine mounted to the horizontal sections of said left and right subframes.

24. The frame of claim 23, wherein said conventional automobile engine is a V-8 engine.

25. The frame of claim 24, further comprising a radiator affixed to said frame using a plurality of said universal brackets.

26. The motorized vehicle frame of claim 25, further comprising coolant in at least one frame tube for use in said engine and said radiator.

27. The motorized vehicle frame of claim 26, further comprising at least one conduit between said frame tube and said radiator for the flow of fluid therebetween and one conduit between said frame tube and said engine for the flow of fluid therebetween.

28. The frame of claim 23, further including an alternator with an alternator belt; said alternator being movably affixed at one point of said alternator to the front of said engine; said alternator being movably affixed at a second point of said alternator to one end of a movable strut; wherein the other end of said movable strut is movably affixed to a tube of said subframe, thereby allowing the alternator to be positioned to obtain proper tension in the alternator belt.

29. The motorized vehicle frame of claim 28, wherein a universal bracket is used to affix said other end of said movable strut to a tube of the subframe and wherein the mounting hole in said universal bracket has a semi-circular countersunk portion, and further including a washer with a semi-circular cross section and a fastener to swivelably affix said other end of said movable strut to said universal bracket.

30. The motorized vehicle frame of claim 7 further including a hydraulic brake system having a master cylinder.

31. The motorized vehicle frame of claim 30, wherein the master cylinder has the same cross-sectional area as the tubes used for the left and right subframes and rear member.

32. The motorized vehicle frame of claim 31, wherein the master cylinder is affixed to a frame tube with said universal bracket.

33. The motorized vehicle frame of claim 32, further comprising brake fluid in at least one frame tube for use in said hydraulic brake system.

34. The motorized vehicle frame of claim 33, further comprising at least one brake line between said frame tube and said master cylinder for the flow of fluid therebetween.

35. A universal bracket for a motorcycle frame having tubing of a uniform cross-sectional size and shape comprising:
two parts, each part having at least one void the approximate size and shape of a fraction of the cross-section of a frame tube;
each of said parts of said universal bracket having at least one co-linear threaded hole which allow said parts to be affixed together adjacent to a frame tube;
said universal bracket having at least one threaded hole for mounting motorcycle parts and accessories to said universal bracket.

36. The universal bracket of claim 35, wherein the void in each part of said universal bracket is the approximate size and shape of one half of the cross-section of a frame tube.

37. The universal bracket of claim 35, wherein the void in each part of said universal bracket is the approximate size and shape of one quarter of the cross-section of a frame tube.

38. The universal bracket of claim 35, wherein said bracket is constructed of material sufficient to allow said bracket to act as a structural member when said bracket is affixed adjacent to at least two parallel tubes in said frame.
